(19) United States
(12) Patent Application Publication
(10) Pub. No.: US 2008/0005763 A1
(43) Pub. Date: Jan. 3, 2008

(54) Broadcast receiver and method for performing closed caption

(76) Inventor: Jae Won Oh, Seoul (KR)

Correspondence Address: MCKENNA LONG & ALDRIDGE LLP;Song K. Jung, 1900 K Street, N.W., Washington, DC, 20006, US

(21) Appl. No.: 11/819,466

(22) Filed: Jun. 27, 2007

(30) Foreign Application Priority Data
Jun. 29, 2006 (KR) 10-2006-0059201

(51) Int. Cl. H04N 7/10

(52) U.S. Cl. 725/32

(57) ABSTRACT

A host comprises a host controller configured to receive a first call for a specified attribute for closed caption from an application program; and the host controller further configured to return a predefined value to the application program or to perform exception handling in response to the first call when the specified attribute for closed caption is not supported by the host. And, the host controller is further configured to receive a second call requesting an array of available attributes for closed caption from the application program and to return the array of available attributes to the application program in response to the second call. Also, the host controller is further configured to return an array of available attributes for closed caption to the application program in response to the first call when the specified attribute for closed caption is not supported by the host.

This application claims the benefit of Korean Patent Application No. 10-2006-0059201, filed on Jun. 29, 2006, which is hereby incorporated by reference as if fully set forth herein.

### BACKGROUND

1. Field of the Disclosure

The present disclosure relates to broadcast receivers and methods for performing a closed caption.

2. Background

In general, a caption may be largely divided into an open caption and a closed caption.

The open caption is a method for allowing a broadcast provider to forcedly display a caption signal relating to a news flash or emergency in a video signal section of a television signal on the screen of a television receiver through screen overlapping. The closed caption is a method for transmitting speech contents or other screen information carried in a Vertical Blanking Interval (VBIo), which is not used in a television signal, and displaying the speech contents or the other screen information on the screen of a television receiver according to the selection of a user.

The closed caption is originally developed for hearing impaired persons and is called “closed” in view of a service for restricted viewers. However, the closed caption is currently being used in a variety of application programs such as a foreign language learning program and the use range thereof gradually expands. In United States, the closed caption has been used since 1978 and it is prescribed that a closed caption function is obligatorily mounted in a display device having at least a predetermined size in Federal Communications Commission (FCC). In these days when analog broadcasting environments transitions to digital broadcasting environments, it is prescribed that a more improved digital television closed caption (DTVCC) function is mounted in all digital television (DTV) receivers.

### SUMMARY

Accordingly, the present disclosure is directed to broadcast receivers and methods for performing a closed caption that substantially obviate one or more problems described above.

For example, the disclosure may disclose broadcast receivers and methods for performing a closed caption capable of allowing an application program to call an attribute value of an attribute which is not supported by middleware and determining an attribute which can be supported by the middleware.

Advantages, objects, and features of the invention in part may become apparent in the description which follows and in part may become apparent to those having ordinary skill in the art upon examination of the following or may be learned from practice of the disclosure. The objectives and other advantages of the invention may be realized and attained by the structures and processes described in the written description, in the claims, and in the appended drawings.

To achieve these objects and other advantages and in accordance with the purpose of the invention, as embodied and broadly described herein, a host includes a host controller configured to receive a first call for a specified attribute for closed caption from an application program. And, the host controller further configured to return a predefined value to the application program or to perform exception handling in response to the first call when the specified attribute for closed caption is not supported by the host.

In another aspect of the present disclosure, a host includes a host controller configured to receiving a call requesting an array of available attributes for closed caption from an application program. And, the host controller further configured to return the array of available attributes in response to the call.

In another aspect of the present disclosure, a method for performing closed caption in a cable system includes receiving a first call for a specified attribute for closed caption from an application program; and returning a predefined value to the application program or performing exception handling in response to the first call when the specified attribute for closed caption is not supported by a host.

In another aspect of the present disclosure, a method for performing closed caption in a cable system includes receiving a first call requesting an array of available attributes for closed caption from an application program; and returning the array of available attributes for closed caption in response to the first call.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the disclosure are incorporated in and constitute a part of this application. The drawings together with the description serve to explain the principle of the invention. In the drawings:

FIGS. 1A and 1B are exemplary diagram of exception handling;

FIG. 2 is a view showing a case of changing n attribute values using methods;

FIGS. 3A and 3B are flowcharts illustrating a method for performing a closed caption according to an embodiment of the present invention; and

FIG. 4 is a block diagram showing an apparatus for performing a closed caption according to the embodiment of the present invention.

### DETAILED DESCRIPTION

Reference will now be made in detail to broadcast receivers and methods for performing closed caption according to the various embodiments, examples of which are illustrated in the accompanying drawings. Wherever possible, the same reference numbers will be used throughout the drawings to refer to the same or like parts for simplicity.

Hereinafter, broadcast receivers and methods for performing a closed caption according to an embodiment of the present disclosure will be described in detail with reference to the accompanying drawings.

When a closed caption function is used, an application program can operate attributes (for example, CC_attribute) related to the function. At this time, the application program may be executed in a television receiver having middleware mounted thereon.

Hereinafter, in the present disclosure, for example, an OpenCable Application Platform (OCAP) is used as a data broadcast platform. Among Application Program Interface (APIs) which are basically required in the OCAP, for example, a “ClosedCaptioningAttribute” class among a plurality of classes in a media API will be described.

In the OCAP, a closed caption function can be used in only a permitted application program. Also, the OCAP defines that the middleware may not support all attributes of the closed caption function.

The “ClosedCaptioningAttribute” class represents a system wide preference of closed-captioning representation. Among the plurality of fields of the “ClosedCaptioningAttribute” class, fields related to the closed caption will now be described. For convenience of description, the fields are marked by double quotation marks.

For example, a “CC_ATTRIBUTE_FONT_ITALICIZED” field indicates a font face attribute of a closed-captioning text. A “CC_ATTRIBUTE_FONT_STYLE” field indicates a font style attribute of a closed-captioning text. A “CC_ATTRIBUTE_FONT UNDERLINE” field indicates a font face attribute of a closed-captioning text. A “CC_ATTRIBUTE_PEN_BG_COLOR” field indicates a pen back ground color attribute to draw closed-captioning text. A “CC_ATTRIBUTE_PEN_BG_OPACITY” field indicates a pen back ground opacity attribute of a closed-captioning text. A “CC_ATTRIBUTE_PEN_FG_COLOR” field indicates a pen color attribute to draw closed-captioning text. A “CC_ATTRIBUTE_PEN_FG_OPACITY” field indicates a pen opacity attribute of a closed-captioning text.

A “CC_ATTRIBUTE_PEN_SIZE” field indicates a font size attribute of a closed-captioning text. A “CC_ATTRIBUTE_WINDOW_BORDER_COLOR” field indicates a border color attribute of a closed-captioning window. A “CC_ATTRIBUTE_WINDOW_BORDER_TYPE” field indicates a border type attribute of a closed-captioning window. A “CC_ATTRIBUTE_WINDOW_FILL_COLOR” field indicates a window fill color attribute of a closed-captioning window. A “CC_ATTRIBUTE_WINDOW_FILL_OPACITY” field indicates a border type attribute of a closed-captioning window. The fields have an equivalent attribute assigned for an analog captioning.

As described above, the application program can use the closed caption function and acquire or change the attribute values of the attributes of the function (for example, a closed caption). In order to acquire or change the attribute values, the application program uses methods provided by the OCAP.

The “ClosedCaptioningAttribute” class includes getCCAttribute( ), getCCCapability( ), and setCCAttribute( ) methods. The getCCAttribute( ) method returns a current attribute value applied to a closedcaptioning text on a screen. The getCCCapability( ) method returns a possible attribute value applied to a closedcaptioning text on a screen. The setCCAttribute( ) method sets a preferred attribute value applied to a closed-captioning text on a screen.

Hereinafter, methods for performing a closed caption according to the embodiment of the present disclosure will be described.

For example, a process when an application program calls a method for an attribute which is supported by middleware will be described. At this time, it is assumed that the application program changes the attribute value of a “pen foreground color” attribute.

First, the application program calls the “getCCCapability( )” method in order to determine a possible attribute value of a specific attribute supported by the middleware. That is, the application program defines and calls an ‘attribute’ parameter and a ‘ccType’ parameter of the “getCCCapability (int attribute, int ccType)” method and the middleware returns the possible attribute value which can be supported by the ‘attribute’ parameter of the ‘ccType’ parameter defined in the method. Accordingly, the application program can determine the possible attribute value of the specific attribute supported by the middleware from the returned result.

For example, when the application program defines and calls ‘CC_DIGITAL’ as the ‘ccType’ parameter of the “getCCCapability( )” method and ‘CC_ATTRIBUTE_PEN_FG_COLOR’ as the ‘attribute’ parameter thereof, the middleware returns a possible pen foreground (FG) color (e.g. white color, blue color, and black color) of the digital type (ccType) according to the values defined by the parameters of the “getCCCapability( )” method. Accordingly, the application program can determine a possible pen FG color of the digital type supported by the middleware and whether the preferred attribute value is included in the possible font color. That is, the application program determines whether the middleware supports the preferred attribute value. The application program can determine whether the middleware can support the attribute value to be changed.

When the application program changes the attribute value to the preferred attribute value, the application program needs to determine the current attribute value supported by the middleware. This is because the attribute value does not need to be changed if the preferred attribute value is equal to the current attribute value.

Accordingly, the application program calls the “getCCAttribute( )” method in order to determine the current attribute value supported by the middleware. That is, the application program defines and calls an ‘attribute’ parameter and a ‘ccType’ parameter of the “getCCAttribute (int attribute, int ccType)” method and the middleware returns the current attribute value supported by the ‘attribute’ parameter of the ‘ccType’ parameter defined in the method. Accordingly, the application program can determine the current attribute value of the specific attribute supported by the middleware from the returned result.

For example, when the application program defines and calls ‘CC_DIGITAL’ as the ‘ccType’ parameter of the “getCCAttribute( )” method and ‘CC_ATTRIBUTE_PEN_FG_COLOR’ as the ‘attribute’ parameter thereof, the middleware returns a current font color (e.g. any one of white color, blue color, and black color) of the digital type (ccType) according to the values defined by the parameters of the “getCCAttribute( )” method. Accordingly, the application program can determine a current font color of the digital type of the middleware and whether the preferred attribute value is equal to the current font color.

The application program determines the possible attribute value and the current attribute value of the specific attribute (e.g. the pen FG color) supported by the middleware through the above-described process. At this time, the order of calling the two methods may be changed.

Finally, the application program calls the “setCCAttribute( )” method in order to change the current attribute value to another attribute value among the attribute values of the specific attribute which can be supported by the middleware. That is, the application program defines and calls an ‘attribute’ parameter, a ‘value’ parameter, and a ‘ccType’ parameter of the “setCCAttribute( )” method and the middleware sets the ‘value’ of the ‘attribute’ of the ‘ccType’ defined in the called method.

For example, when the application program defines and calls ‘CC_DIGITAL’ as the ‘ccType’ parameter of the “setCCAttribute( )” method, ‘CC_ATTRIBUTE_PEN_FG_COLOR’ as the ‘attribute’ parameter thereof, and ‘blue color’ as the ‘value’ parameter thereof, the middleware sets the pen FG color of the digital type to blue color according to the calling (when it is assumed that the current attribute value of the “pen FG color” attribute is ‘black color’).

As described above, the application program can change the attribute value of the specific attribute using the “getCCCapability( )” method, the “getCCAttribute( )” method, and the “setCCAttribute( )” method. Referring to the above-described example, the application program calls the “getCCCapability( )” method and the “getCCAttribute( )” method to determine that the middleware can support the attribute values ‘white color’, ‘blue color’ and ‘black color’ as the attribute value of the “pen FG color” attribute and the current attribute value is ‘black color’ and calls the “setCCAttribute( )” method to change the attribute value from ‘black color’ to ‘blue color’.

However, if the application program tries to call or change the attribute value of an attribute which is not supported by the middleware using the methods, the middleware cannot process the called methods with respect to the attribute which is not supported by the middleware. Hereinafter, the process for this case will now be described according to the present disclosure.

When the application program calls any one of the above-described methods, the middleware determines which method is called and returns the determined result. At this time, if it is determined that the called method is an attribute which is not supported by the middleware, the middleware may return a predefined value or perform the exception handling for the calling. Accordingly, when the predefined value is returned or the exception handling for the calling is performed, the application program can determine that the called attribute is not supported by the middleware.

The predefined value may be, for example, a null value or an array of zero-length. The exception includes an unchecked exception and a checked exception. The unchecked exception indicates serious errors, and a sentence for checking the errors may not be contained in a program. Since the errors immediately cause any problem upon the execution or the compiling of the program, the program must be immediately corrected. That is, the error indicates a serious problem which cannot be restored and caught, such as the end of the program, and RuntimeException indicates a serious problem which cannot be restored and can be caught. The checked exception is an error which may occur or may not occur according to a condition. If a sentence for checking the error is not contained in a program, the occurrence of the error cannot be recognized or the cause of the error cannot be checked when the error occurs later. The checked exception is an exception in which a compiler checks whether a relationship between the occurrence and the handling of exception is properly established. Therefore, if there is a probability that the checked exception occurs in any method, the exception must be necessarily handled in any position of the program. If the exception is not handled, a compiling error may occur.

For example, the application program calls the possible attribute value of the specific attribute which can be supported by the middleware using the “getCCCapability (ccType, attribute)” method. At this time, if the application program defines and calls the attribute which is not supported by the middleware as the ‘attribute’ parameter, the middleware cannot process the called method. Thus, the application program may not operate or malfunction may occur.

Accordingly, in the present disclosure, the middleware determines whether the application program calls the attribute which can be supported by the middleware and returns the predetermined value or performs the exception handling of the calling if it is determined that the application program calls the attribute which is not supported by the middleware. For example, the middleware performs the exception handling for the calling or returns the null value or the array of zero-length if it is determined that the application program calls the attribute which is not supported by the middleware using the “getCCCapability” method.

As described above, when the application program calls the attribute which is not supported by the middleware using the predefined method, the middleware returns the predefined value or performs the exception handling for the calling. When the middleware returns the predefined value or performs the exception handling for the calling, the application program determines that the attribute is not supported by the middleware.

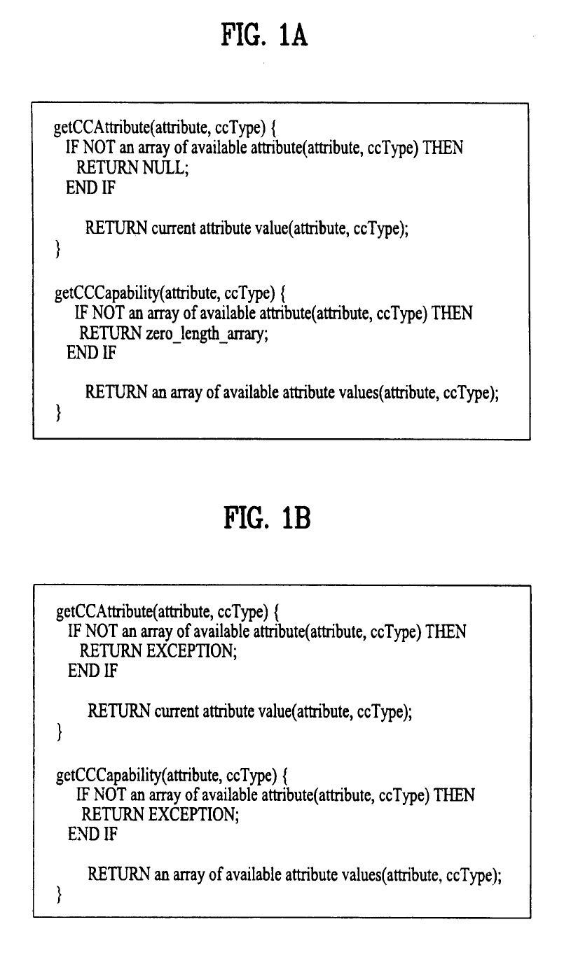

Hereinafter, the operation of the middleware when the application program calls the attribute which is not supported by the middleware using the method will be described with reference to the accompanying drawings. FIG. 1A is an exemplary diagram where the middleware returns the predefined value when the application program calls the attribute which is not supported by the middleware and FIG. 1B is an exemplary diagram where the middleware performs the exception handling for the calling when the application program calls the attribute which is not supported by the middleware.

For example, the application program calls the current attribute value of the specific attribute supported by the middleware using the “getCCAttribute( )” method. The middleware determines whether the application program calls the attribute supported by the middleware. If it is determined that the application program calls the attribute which is not supported by the middleware, the middleware returns the null value (or the array of zero-length) in the case shown in FIG. 1A and performs the exception handling for the calling in the case shown in FIG. 1B such that the application program determines that the attribute is not supported by the middleware.

However, if it is determined that the application program calls the attribute which supported by the middleware, the middleware returns the current attribute value of the attribute supported by the middleware and performs the process for the calling.

Alternatively, when the application program calls the attribute value of the specific attribute which can be supported by the middleware using the “getCCCapbaility( ) method, the middleware determines whether the attribute specified in the method is the attribute which is not supported by the middleware.

If it is determined that the specified attribute is the attribute which is not supported by the middleware, the middleware returns the array of zero-length in the case shown in FIG. 1A and performs the exception handling for the calling in the case shown in FIG. 1B such that the application program determines that the specified attribute is not supported by the middleware.

In contrast, if it is determined that the specified attribute is the attribute which can be supported by the middleware, the middleware returns the possible attribute value of the attribute supported by the middleware and performs the process for the calling.

By the above-described process, the middleware performs the process without non-operation or malfunction even when the application program calls the attribute which is not supported by the middleware using the method.

The above description relates to the process when the application program calls the attribute value of the attribute which is not supported by the middleware using the method. However, in the OCAP, since the middleware may not support all the attributes of 12 fields, the application program cannot determine which attribute is supported by the middleware. Accordingly, the application program must call the attributes and check which attributes can be supported by the middleware through the response of the middleware. Therefore, a case of efficiently performing the closed caption by determining which attribute can be supported by the middleware using a specific method will now be described.

That is, conventionally, the application program can call the attributes using the above-described methods and determine whether the attributes can be supported by the middleware through the value returned by the middleware. For example, if 12 attributes exists in association with the closed caption, the application program can determine which attribute can be supported by the middleware by calling the twelve methods.

Accordingly, in the present disclosure, the application program can determine which attribute can be supported by the middleware by calling only one method.

In the present disclosure, for example, the application program defines and uses a method for allowing the middleware to return a list of attributes which can be supported by the middleware. This method is called “getAvailableCCAttributes (int ccType)”. At this time, the name of the defined method is arbitrarily determined by the present applicant for convenience of description, the present disclosure is not limited to the above-described method and the scope of the present disclosure is determined by the technical spirit of the present specification.

Now, the “getAvailableCCAttributes (int ccType)” method will be described. The method can specify only the ‘ccType’. That is, when the application program defines an analog or digital type as the ‘ccType’ and calls the above method, the middleware returns a list of attributes which can be supported by the middleware in association with the ‘ccType’ specified by the application program. That is, the middleware returns an array of closed caption attributes which can be supported by the middleware among the attributes having a prefix “CC_ATTRIBUTE_*”.

Therefore, the application program can determine which attribute can be supported by the middleware through the value returned in response to the calling of the “getAvailableCCAttributes( )” method. In addition, the application program can determine that attributes except for the attributes returned in response to the calling are not supported by the middleware.

Accordingly, when the attribute value of a specific attribute of the middleware is desired to be changed, the application program can determine whether an attribute to be changed is supported by the middleware using the method.

Thus, it is possible to prevent the methods from being unnecessarily called.

As a result, when the “getAvailableCCAttributes( )” method is used, the application program can previously determine which attribute is supported by the middleware.

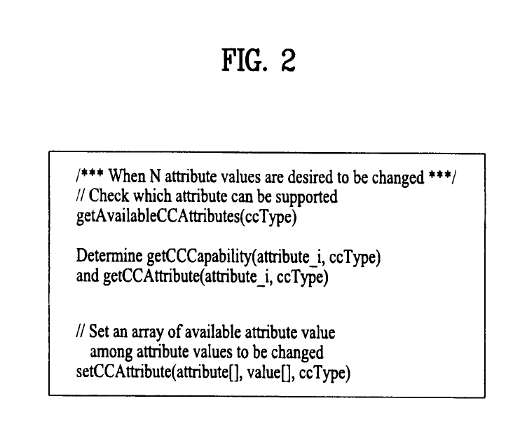

In FIG. 2, the application program can determine which attribute is supported by the middle through the getAvailableCCAttributes( )” method, check the possible attribute value and the current attribute value of a specific attribute among the determined attributes through the “getCCCapability( )” method and the “getCCAttribute( )” method, and change n attributes values through the “setCCAttribute( )” method.

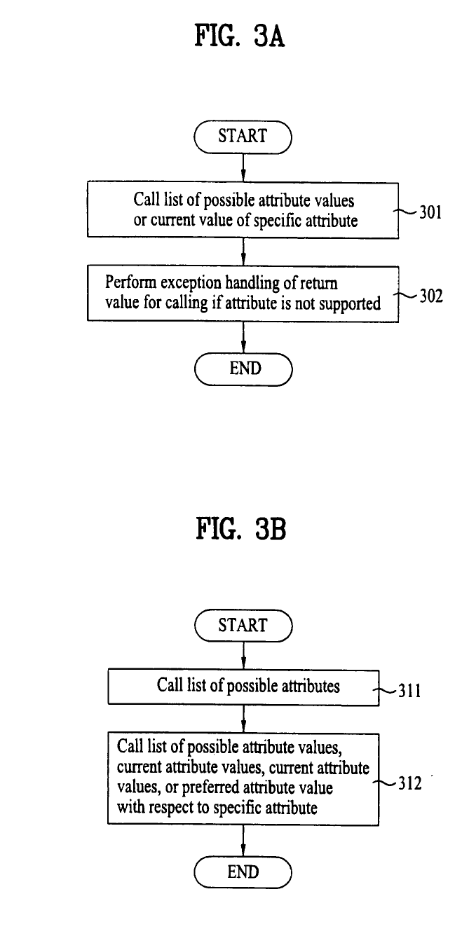

Now, a method for performing a closed caption will be described. FIG. 3A is a flowchart illustrating a method for performing a closed caption when an application program calls an attribute which is not supported by middleware.

First, in FIG. 3A, the middleware receives the calling of a specific attribute using a method from the application program as shown in FIG. 1A or 1B (s301). When the calling is received, the middleware determines whether the called attribute is supported by the middleware.

If it is determined that the called attribute is supported by the middleware, the middleware returns an attribute value according to the property of the method. In contrast, if it is determined that the called attribute is not supported by the middleware, the middleware returns a predetermined value (e.g. a null value or an array of zero-length) or performs exception handling for the calling (s302).

FIG. 3B is a flowchart illustrating a method for performing a closed caption when the “getAvailableCCAttributes( )” method is used.

In FIG. 3B, the “getAvailableCCAttributes( )” method defined in FIG. 2 is used. When the application program calls a list of attributes supported by the middleware using the “getAvailableCCAttributes( )” method, the middleware receives the calling (s311).

Then, the middleware returns the list of attributes supported by the middleware in response to the received calling (s312). The application program can determine which attribute can be supported by the middleware through the returned list of attributes. In addition, the application program can change the attribute value of the attribute supported by the middleware to a desired attribute value, for example, through the process shown in FIG. 3A.

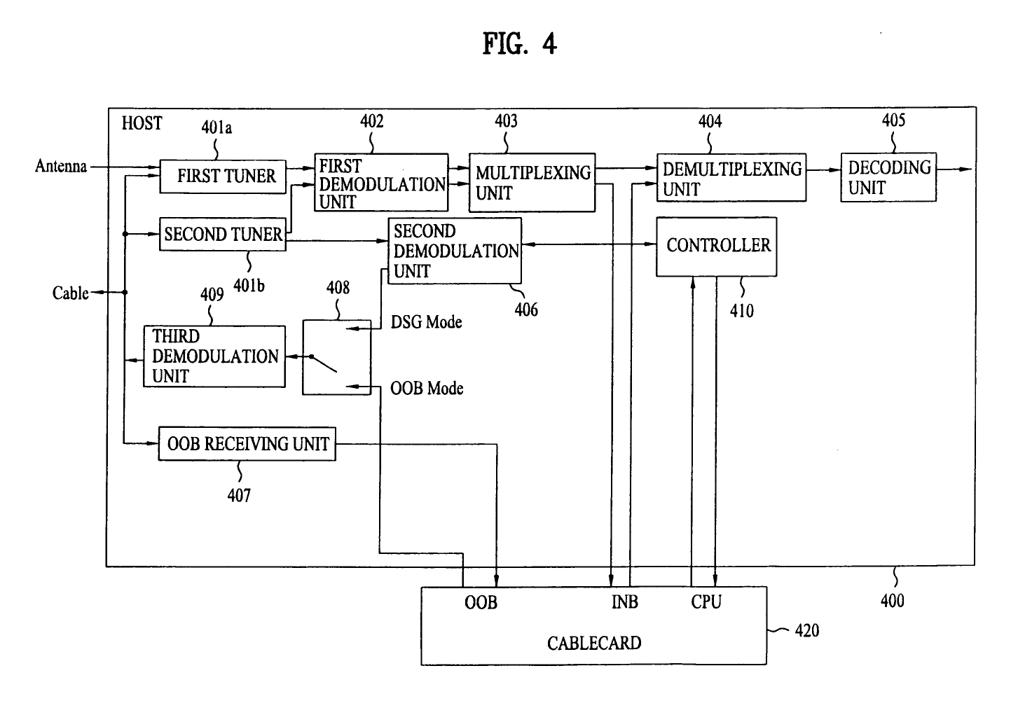

Next, broadcast receiver including an apparatus for performing a closed caption according to the embodiment of the present disclosure will be described. FIG. 4 is an exemplary block diagram including an apparatus for performing a closed caption according to the embodiment of the present disclosure.

A cable broadcasting receiver according to the present disclosure shown in FIG. 4 may include a host and a communication device which can be attached to or detached from the host. At this time, the communication device may a cablecard.

In general, the host can receive only a cable broadcasting signal or receive at least one of a cable broadcasting signal, a terrestrial broadcasting signal and a satellite broadcasting signal. Accordingly, FIG. 4 shows a case where the host can receive at least one of the cable broadcasting signal, the terrestrial broadcasting signal and the satellite broadcasting signal.

Meanwhile, a bi-directional communication method between a cable broadcasting receiver and a broadcasting station includes two methods. As a method for an uplink service in an open cable, there are an out-of-band (OOB) mode and a DOCSIS Set-top Gateway (DSG) mode.

Accordingly, a viewer can selectively view a desired program through the host using any one of the two modes. Alternatively, a viewer can directly participate in a broadcasting program or selectively view necessary information. A data broadcasting service may be provided through the two modes.

The OOB system is the standard of transport specifications between a cable broadcasting station and an intersec instrument within a set-top box. The DSG mode means a transport mode between a cable modem control system of a cable broadcasting station and a DOCSIS-based cable modem within a set-top box. The DOCSIS can transmit data using the cable modem.

FIG. 4 shows a cable broadcasting receiver using a combination of the OOB mode and the DSC mode.

Referring to FIG. 4, the host 400 includes a first tuner 401A, a second tuner 401B, a first demodulation unit 402, a multiplexing unit 403, a demultiplexing unit 404, a decoding unit 405, a second demodulation unit (DOCSIS) 406, an OOB receiving unit 407, a switching unit 408, a third demodulation unit 409, and a controller 410.

The first tuner 401A tunes only a specific channel frequency of a cable audio/video (A/V) broadcasting signal transmitted in-band through a cable or a terrestrial A/V broadcasting signal transmitted through an antenna, and outputs the tuned signal.

At this time, the terrestrial broadcasting signal may be modulated by a Vestigial Sideband Modulation (VSB) method and the cable broadcasting signal may be modulated by a Quadrature Amplitude Modulation (QAM) method.

The first demodulation unit 402 can demodulate the terrestrial broadcasting signal and the cable broadcasting signal according to the respective modulation methods although the methods for transmitting the signals are different from each other. Accordingly, the first demodulation unit 402 can demodulate the signal selected by the first tuner 401A by the VSB method or the QAM method.

The signal demodulated by the first demodulation unit 402 is multiplexed by the multiplexing unit 403 such that the cable broadcasting signal is output to the cablecard 420 and the terrestrial broadcasting signal is output to the demultiplexing unit 404.

The embodiment shown in FIG. 4 shows a case where the cablecard 420 can process multi-stream. Accordingly, the cablecard 420 allows a user to view at least two multiplexed broadcasting signals through the host 400.

The demultiplexing unit 404 receives the multiplexed broadcasting signal, demultiplexes the received broadcasting signal into a plurality of streams, and outputs the plurality of streams.

The decoding unit 405 receives and decodes the broadcasting signal demultiplexed by the demultiplexing unit 404. The decoding unit 405 decodes the demultiplexed broadcasting signal and outputs an A/V signal.

The second tuner 401B tunes a specific channel frequency of the data broadcasting signal transmitted through the cable in the DSC mode and outputs the tuned signal to the second demodulation unit 406. The second demodulation unit 406 demodulates the data broadcasting signal of the DSC mode and outputs the demodulated broadcasting signal to the controller 410.

The third tuner 407 tunes a specific channel frequency of a downlink data broadcasting signal transmitted through the cable in the OOB mode and outputs the tuned signal to the cablecard 420.

When bi-directional communication between the cable broadcasting station and the cable broadcasting receiver is possible, uplink information transmitted from the cable broadcasting receiver to the cable broadcasting station may be transmitted in the OOB mode or the DSG mode. Accordingly, the apparatus for performing the closed caption according to the embodiment of the present disclosure may include the switching unit 408 so as to select any one of the modes and transmit information.

In the OOB mode, user information or system diagnosis information is output to the third demodulation unit 409 through the cablecard 420 and the switching unit 408 and the third demodulation unit 409 modulates the output signal using a Quadrature Phase Shift Keying (QPSK) modulation method and transmits the modulated signal to the cable broadcasting station through the cable. If the broadcasting signal of the user is transmitted in the DSG mode, the information is output to the demodulation unit 409 through the controller 410 and the switching unit 408 and is then modulated by the demodulation unit 409 using a QAM-16 modulation method to be transmitted to the cable broadcasting station through the cable.

When the terrestrial broadcasting signal is received, the cablecard 420 shown in FIG. 4 can receive a multi-stream broadcasting signal from the multiplexing unit 403. At this time, when the received broadcasting signal is scrambled, the cablecard 420 descrambles the scrambled broadcasting signal such that the cable broadcasting signal is normally viewed.

The apparatus for performing the closed caption according to the present disclosure includes a controller which, when an application program calls a “getCCAttribute( )” method, a “getCCCapability( )” method or a “setCCAttribute( )” method with respect to a specific attribute, controls an attribute to be returned when a specific attribute is supported and controls a predefined value (for example, a null value or an array of zero-length) to be returned or exception handling of the calling to be performed when the specific attribute is not supported. The controller also controls a list of attributes, which can be supported, to be returned when the application program calls a “getAvailableCCAttributes( )” method.

Although the method and apparatus for performing the closed caption are described using the OCAP, the present disclosure is not limited to this embodiment and is applicable to an MHP or ACAP.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A host comprising:
a host controller configured to receive a first call for a specified attribute for closed caption from an application program; and
the host controller further configured to return a predefined value to the application program or to perform exception handling in response to the first call when the specified attribute for closed caption is not supported by the host.

2. The host of claim 1, wherein the host controller is further configured to receive a second call requesting an array of available attributes for closed caption from the application program and to return the array of available attributes to the application program in response to the second call.

3. The host of claim 1, wherein the host controller is further configured to return an array of available attributes for closed caption to the application program in response to the first call when the specified attribute for closed caption is not supported by the host.

4. The host of claim 1, wherein the predefined value is any one of a null value and an array of zero-length.

5. The host of claim 3, wherein the array of available attributes for closed caption is in accordance with a parameter value of the type of the array of attributes of the first call.

6. The host of claim 5, wherein the parameter value of the type is any one of a analog type and a digital type.

7. The host of claim 1, wherein the application program includes an Open Cable Application Platform (OCAP) application, Advanced Common Application Platform (ACAP), and Multimedia Home Platform (MHP).

8. A host comprising:
a host controller configured to receiving a call requesting an array of available attributes for closed caption from an application program; and
the host controller further configured to return the array of available attributes in response to the call.

9. The host of claim 8, wherein the array of available attributes is in accordance with a parameter value of the type of the array of attributes.

10. The host of claim 9, wherein the parameter value is any one of an analog type and a digital type.

11. The host of claim 8, wherein the application program includes an Open Cable Application Platform (OCAP) application, Advanced Common Application Platform (ACAP), and Multimedia Home Platform (MHP).

12. A method for performing closed caption in a cable system, the method comprising:
receiving a first call for a specified attribute for closed caption from an application program; and
returning a predefined value to the application program or performing exception handling in response to the first call when the specified attribute for closed caption is not supported by a host.

13. The method of claim 12, further comprising:
receiving a second call requesting an array of available attributes for closed caption from the application program; and
returning the array of available attributes to the application program in response to the second call.

14. The method of claim 12, further comprising returning an array of available attributes for closed caption to the application program in response to the first call when the specified attribute for closed caption is not supported by the host.

15. The method of claim 12, wherein the predefined value is any one of a null value and an array of zero-length.

16. The method of claim 14, wherein the array of available attributes for closed caption is in accordance with a parameter value of the type of the array of attributes of the first call.

17. The method of claim 16, wherein the parameter value of the type is any one of a analog type and a digital type.

18. The method of claim 12, wherein the application program includes an Open Cable Application Platform (OCAP) application, Advanced Common Application Platform (ACAP), and Multimedia Home Platform (MHP).

19. A method of performing closed caption in a cable system, the method comprising:
receiving a first call requesting an array of available attributes for closed caption from an application program; and
returning the array of available attributes for closed caption in response to the first call.

20. The method of claim 19, further comprising:
receiving a second call requesting for a specified attribute in the array of available attributes for closed caption in response to the first call from an application program; and
returning a attribute value of the specified attribute for closed caption in response to the second call or setting a attribute value of the specified attribute for closed caption in response to the second call.

21. The method of claim 19, wherein the application program includes an Open Cable Application Platform (OCAP) application, Advanced Common Application Platform (ACAP), and Multimedia Home Platform (MHP).
